(19) United States
(12) Patent Application Publication
(10) Pub. No.: US 2023/0122338 A1
(43) Pub. Date: Apr. 20, 2023

(54) Knowledge Graph Driven Content Generation

(71) Applicant: International Business Machines Corporation, Armonk, NY (US)

(72) Inventors: Sinem Guven Kaya, New York, NY (US); Bing Zhou, Rye, NY (US); Yu Deng, Yorktown Heights, NY (US)

(73) Assignee: International Business Machines Corporation, Armonk, NY (US)

(21) Appl. No.: 17/502,484

(22) Filed: Oct. 15, 2021

(51) Int. Cl. G06N 5/02; G06N 3/08

(52) U.S. Cl. CPC G06N 5/02; G06N 3/08

(57) ABSTRACT

Embodiments relate to an intelligent computer platform to support knowledge graph (KG) driven content generation. A KG is created from one or more knowledge articles. The created KG includes individual nodes representing individual physical object and individual edges representing a hardware state characteristic of a physical object represented in a corresponding node. A trained computer vision model is leveraged to recognize one or more physical components and localize an active state of the recognized physical components. Content is generated responsive to the localized active state and the hardware state characteristic represented in the KG, and a control signal is dynamically issued to an operatively coupled device associated with the generated content. The control signal is configured to selectively control an event injection responsive to synchronization of the recognized one or more physical components and the generated content.

### BACKGROUND

The present embodiments relate to an artificial intelligence (AI) platform and associated methodology to support computer vision and object detection for dynamic instruction generation. More specifically, the embodiments relate to leveraging a knowledge graph to support computer vision and object detection, and employing the knowledge graph to interface with the dynamic instruction generation as supported by the computer vision and object detection.

Technical support service providers typically maintain a large quantity of products in order to meet the needs of their clients. Delivering multi-dimensional service necessitates maintaining a significant technical force trained on a wide range of products. Given an increasing product portfolio and pressure for technicians to cover multiple domains equally effectively, training these technicians to be experts at every product in the product portfolio is challenging and serves as an impediment.

Remote support is often times referred to as remote technical support. In the software field, remote support may be enabled through connection of a computing device to a network with a technician remotely connected to the computing device. Such remote support may provide the technician with access to files, applications, and network resources. Through the remote access, the technician may diagnose and resolve software issues of the computing device that is the subject of the technical support. In an exemplary embodiment, the computing device may be a processor enabled device, including but not limited to a personal computer, a processor enabled appliance, etc. In an embodiment, the computing device is a physical object with an Internet Protocol (IP) address for network connectivity. Accordingly, technical support and for software related issues may be supported on a remote basis.

Hardware technical support requires physical presence of a technician to resolve one or more physical ailments or limitations of the product. However, scaling technician skills is challenging, with the challenges increasing with expansion of physical device products. One such scaling approach is directed at augmented reality (AR) driven self-enablement where the technician receives instructions directly from an AR system through virtual procedures, which are interactive three-dimensional representations of text based knowledge articles that describe how to perform step-by-step repair actions. This self-enablement eliminates dependency on remote experts, and reduces support timelines by providing instant or near instant access to relevant information rather than experience a delay associated with expert repair guidance. However, the data used to support AR is limited, which effectively limits the scope of the AR. Solutions for efficiency understanding and processing knowledge articles and article content to support AR driven self-enablement are extremely difficult at a practical level.

### SUMMARY

The embodiments include a system, computer program product, and method for computer vision and object detection for dynamic content generation.

In one aspect, a computer system is provided with a processing unit and memory for use with an artificial intelligence (AI) computer platform for knowledge graph (KG) driven content generation. The processing unit is operatively coupled to the memory and is in communication with the AI platform and embedded tools, which include a KG manager, a director, and a signal manager. The KG manager functions to create a KG from one or more knowledge articles. The KG includes nodes and edges, with nodes representing a physical object and an individual edge representing a hardware state characteristic of the physical object. The director functions to leverage a trained computer vision model to recognize one or more physical components and localize an active state of the recognized physical components. The director further dynamically generates content responsive to the localized active state and the hardware state characteristic represented in the KG. The signal manager functions to dynamically issue a control signal to an operatively coupled device associated with the generated content. The control signal is configured to selectively control an event injection responsive to synchronization of the recognized one or more physical components and the generated content.

In another aspect, a computer program device is provided to support knowledge graph (KG) driven content generation. The program code is executable by a processor to create a KG from one or more knowledge articles. The KG includes nodes and edges, with nodes representing a physical object and an individual edge representing a hardware state characteristic of the physical object. The program code leverages a trained computer vision model to recognize one or more physical components and localize an active state of the recognized physical components. The program code generates content responsive to the localized active state and the hardware state characteristic represented in the KG. The program code dynamically issues a control signal to an operatively coupled device associated with the generated content. The control signal is configured to selectively control an event injection responsive to synchronization of the recognized one or more physical components and the generated content.

In yet another aspect, a method is provided for supporting knowledge graph (KG) driven content generation. A KG is created from one or more knowledge articles. The KG includes nodes and edges, with nodes representing a physical object and an individual edge representing a hardware state characteristic of the physical object. A trained computer vision model is leveraged to recognize one or more physical components and localize an active state of the recognized physical components. Content is generated responsive to the localized active state and the hardware state characteristic represented in the KG. A control signal is dynamically issued to an operatively coupled device associated with the generated content. The control signal is configured to selectively control an event injection responsive to synchronization of the recognized one or more physical components and the generated content.

These and other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The drawings reference herein forms a part of the specification. Features shown in the drawings are meant as illustrative of only some embodiments, and not of all embodiments, unless otherwise explicitly indicated.

FIG. 1 depicts a system diagram illustrating an artificial intelligence platform computing system and tools to support knowledge graph driven content generation.

FIG. 2 depicts a block diagram illustrating the artificial intelligence platform and the associated tools, as shown and described in FIG. 1, and their associated application program interfaces.

FIG. 3 depicts a flow chart illustrating a process for creating and leveraging a knowledge graph to deliver comprehensive and context-specific AR guidance.

FIG. 4 depicts a flow chart illustrating a process for creating and dynamically maintaining the knowledge graph from a knowledge article.

FIG. 5 depicts a diagram to illustrate an example knowledge graph for a computer system and associated components.

FIG. 6 depicts a flow chart illustrating leveraging the knowledge graph to support a virtual procedure and dynamic instruction generation.

FIG. 7 depicts a block diagram illustrating an example of a computer system/server of a cloud based support system, to implement the system and processes described above with respect to FIGS. 1-6.

FIG. 8 depicts a block diagram illustrating a cloud computer environment.

FIG. 9 depicts a block diagram illustrating a set of functional abstraction model layers provided by the cloud computing environment.

### DETAILED DESCRIPTION

It will be readily understood that the components of the present embodiments, as generally described and illustrated in the Figures herein, may be arranged and designed in a wide variety of different configurations. Thus, the following details description of the embodiments of the apparatus, system, method, and computer program product of the present embodiments, as presented in the Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment. Thus, appearances of the phrases “a select embodiment,” “in one embodiment,” or “in an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

Augmented reality (AR) is understood in the art as integration of digital information with the user's environment in real-time. More specifically, AR is a type of interactive, reality-based display environment that takes capabilities of computer generated display, sounds, text, and effects to enhance a user's real-world experience. AR combines real and computer-based scenes and images to deliver a unified and enhanced view. In comparison to virtual reality (VR), which creates an artificial environment, AR uses an existing environment and overlays new information on top of the existing environment. An example scenario is a technician with limited experience working at a remote location on a machine they are not familiar with, or in one embodiment, where the technician encounters a problem that they have not encountered before. AR is an emerging technology being implemented to support field technicians at remote location, wherein AR provides the field technicians with in-situ visual instructions with appropriate context, while removing a cognitive burden of having to relate an instruction. Accordingly, AR mitigates, and in one embodiment eliminates ambiguity, reduces error, and increases efficiency with repair processes via visual guidance.

As shown and described herein, a system, computer program product, and method are provided to support and enhance content generation for AR through knowledge graph (KG) generation. It is understood in the art that a KG is a representation of a knowledge base that uses a graph structured data model or topology to integrate data. The KG represents knowledge as content and concepts, and relationships between such content and concepts in a graphical format. In an embodiment, the KG includes an ontology that is both human and computer readable, with concepts or objects (also referred to herein as content) represented as nodes and relationships between the concepts or objects represented as edges or links. The present embodiments are directed at creating a KG out of one or more knowledge articles, such as an instruction article, and leveraging the created KG to deliver content, which in an embodiment is comprehensive and context-specific AR guidance for a technician. Such KG support AR guidance may be employed to resolve ambiguity in a virtual procedure instruction, and ensure accuracy of an intended action.

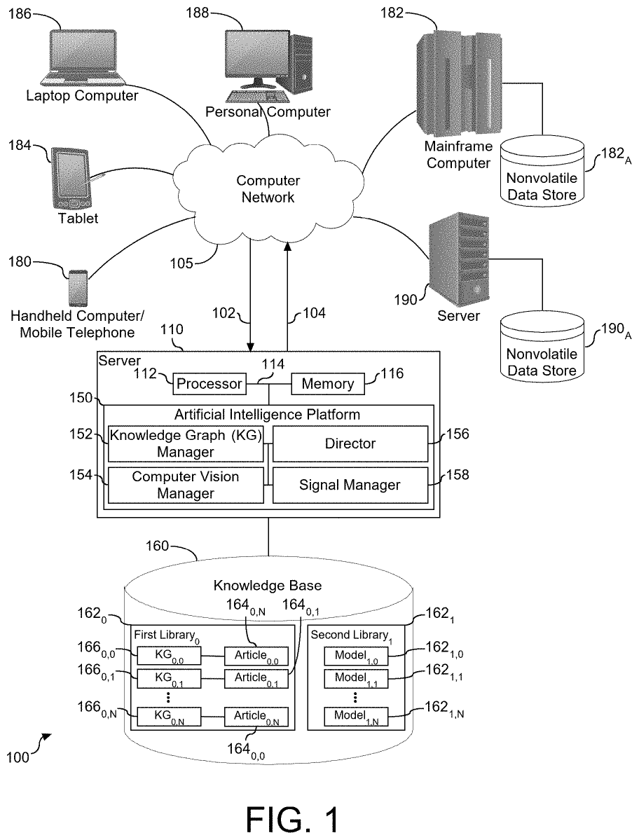

Referring to FIG. 1, a schematic diagram of a knowledge engine platform computing system (100) is depicted. As shown, a server (110) is provided in communication with a plurality of computing devices (180), (182), (184), (186), (188), and (190) across a network connection (105). The server (110) is configured with a processing unit (112) in communication with memory (116) across a bus (114). The server (110) is shown with an artificial intelligence (AI) platform (150) configured with one or more tools to support and enable KG driven content generation, which in an embodiment is configured for application to AR. The server (110) is in communication with one or more of the computing devices (180), (182), (184), (186), (188), and (190) over the network (105). More specifically, the computing devices (180), (182), (184), (186), (188), and (190) communicate with each other and with other devices or components via one or more wired and/or wireless data communication links, where each communication link may comprise one or more of wires, routers, switches, transmitters, receivers, or the like. In this networked arrangement, the server (110) and the network connection (105) enable communication detection, recognition, and resolution. Other embodiments of the server (110) may be used with components, systems, sub-systems, and/or devices other than those that are depicted herein.

The AI platform (150) is shown herein configured to receive input (102) from various sources. For example, the knowledge engine (150) may receive input across the network (105) and/or leverage a data source (160), also referred to herein as a corpus or knowledge base. As shown, the data source (160) is configured with one or more libraries. For exemplary purposes, the data source (160) is shown herein with two libraries, referred to as a first library, library₀ (162₀), and a second library, library₁ (162₁). However, the quantity of libraries should not be considered limiting. The first library₀ (162₀) is configured to store one or more knowledge articles, referred to herein as articles. By way of example, first library (162₀) is shown with article_{0,0} (164_{0,0}), article_{0,1} (164_{0,1}), . . . , and article_{0,N} (164_{0,N}). In an embodiment, the first library₀ (162₀) may include a reduced quantity of articles or an enlarged quantity of articles. Similarly, in an embodiment, the data source (160) may include multiple libraries which are organized or subject to organization by common subjects or themes, although this is not a requirement.

The AI platform (150) is provided with tools to support and enable KG creation and integration of the created KG(s) with a corresponding computer vision model. The tools function to optimize AR and VR applications across the network (105) to support and enable device optimization. The tools include, but are not limited to, a KG manager (152), a computer vision manager (154), a director (156), and a signal manager (158). The AI platform (150) may receive input from the network (105) or leverage the data source (160) to selectively create a KG, or in an embodiment leverage a created KG, to support content generation, which in an embodiment is in the form of context specific AR guidance. The KG manager (152) is configured to create a KG from one or more knowledge or technical articles. Once created, the KG manager (152) stores the created KG in the knowledge base (160) and associates the created KG with a corresponding knowledge article. By way of example, KG_{0,0} (166_{0,0}) is associated with article_{0,0} (164_{0,0}), KG_{0,1} (166_{0,1}) is associated with article_{0,1} (164_{0,1}), . . . , and KG_{0,N} (166_{0,N}) is associated with article_{0,N} (164_{0,N}), and as shown each of these KGs are stored in the knowledge base (160). Accordingly, the KG manager (152) creates the KGs and stores each created KG in the knowledge base (160) together with formation of an association of the created KG with a corresponding knowledge article.

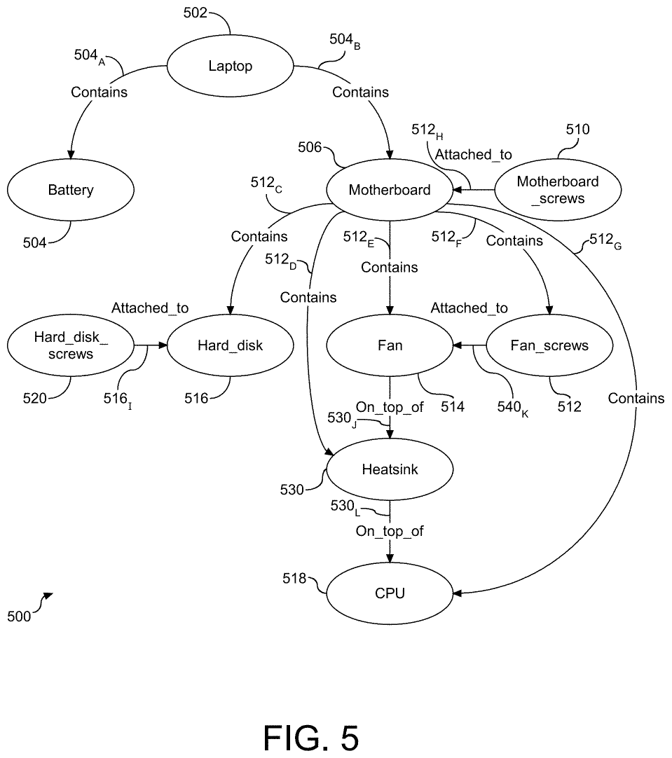

The KG includes nodes and edges, with individual nodes representing a physical object or component referenced or identified in the article, and individual edges, with each edge representing a hardware state characteristic of the physical object. An example KG for a knowledge article is shown and described in FIG. 5. Each hardware component has a state. In an embodiment, the state of a hardware component, also referred to here as the hardware state, may represent a power status of the hardware. Examples of the hardware state power status representation includes, but are not limited to, none, normal, down, online, missing, unreachable, critical, warning, checking firmware, updating firmware, and unsupported. Similarly, in an embodiment, the hardware state characteristic represented in the KG edges may be a physical relationship between the connected nodes. Examples of hardware state physical relationship characteristics include, but are not limited to, attached-to, contains, on-top-of, etc.

The KG manager (152) employs natural language processing (NLP) to create the KG from a corresponding knowledge article. NLP refers to a branch of computer science, and more specifically artificial intelligence (AI), that addresses an ability of a computer program to understand human language as it is written and spoken. NLP combines computational linguistics with statistical, machine learning, and deep learning models to enable processing of human language in the form of text or voice data and to understand its full meaning. The KG manager (152) functions to extract and analyze one or more phrases from a corresponding knowledge article, with the extracted and analyzed one or more phrases referring to one or more physical objects. In an exemplary embodiment, the KG manager (152) leverages NLP to identify one or more phrases referencing one or more physical objects, e.g. hardware objects, noted or referenced in the knowledge article, and to identify one or more relation words between extracted phrases. The KG manager (152) assigns the identified objects to one or more nodes, and assigns the one or more relation words to one or more corresponding edges. In an embodiment, a relation word describes a connection between objects noted or referenced in the extracted phrases. In the context of hardware devices, each identified device has a corresponding hardware state, which in an exemplary embodiment represents a power state, an identified relation word, or a combination of the power state and relation word of the hardware. Similarly, in an embodiment, the relation word may be in the form of an adjective that defines a proximal relationship of the hardware or hardware component to another hardware component. Examples of the relation word assignments to KG edges, including proximal relationship(s), are shown represented in the edges of the KG in FIG. 5. Accordingly, the KG manager (152) leverages NLP to identify objects within phrases and one or more relation words between two or more extracted phrases, and further associates the one or more relation words with hardware state characteristics.

A computer vision model is leveraged for real-time object state detection using annotated data. In an embodiment, if an appropriate computer vision model is not available, a computer vision model may be trained using annotated data, such as annotated image data and/or annotated video data. As shown herein, a computer vision manager (154) is shown operatively coupled to the KG manager (152). The computer vision manager (154) is configured to leverage a trained computer vision model. The computer vision model is an artificial intelligence (AI) model, such as a visual recognition model. Once trained, the trained computer vision model is leveraged to recognize a physical component, and to localize an active state, also referred to herein as a visual state, of the recognized component. Accordingly, the trained vision model is leveraged to identify the visual state, e.g. open, closed, etc., of an object and not merely classify the type of object.

As shown herein, a second library, library₁, (162₁) is shown in the knowledge base (160). The second library, library₁, (162₁) stores computer vision models, hereinafter referred to as models. In an embodiment, the computer vision models may be stored in the same library as the generated KGs, e.g. the first library (162₀). As shown herein by way of example, the second library (162₁) is shown with model_{1,0} (162_{1,0}), model_{1,1} (162_{1,1}), . . . , model_{1,N} (162_{1,N}). In an embodiment, each model may be associated with one or more corresponding KGs. For example, model_{1,0} (162_{1,0}) may be associated with KG_{0,0} (166_{0,0}), model_{1,1} (162_{1,1}) may be associated with KG_{0,1} (166_{0,1}), . . . , model_{1,N} (162_{1,N}) may be associated with KG_{0,N} (166_{0,N}). Similarly, in an embodiment, the second library (162₁) may be positioned in a separate knowledge base (not shown). Accordingly, the models are AI models that are created and managed by the computer vision manager (154). Details of how the models are utilized are shown and described in detail below.

It is understood that different business products and apparatus may each be classified as a domain. In one embodiment, each domain may have one or more corresponding products, each having an associated or created KG and corresponding AI model. For example, in one embodiment, the knowledge base (160) may be organized by domain, with each domain functioning as a library populated with one or more knowledge articles, with each article having a corresponding KG and corresponding AI model. Knowledge articles or libraries of knowledge articles may be added to the knowledge base (160), and corresponding KGs may be created for the added articles of libraries, and one or more trained AI models may be associated with the KGs.

It is understood that knowledge articles may be received by one or more of the computing machines operatively coupled to the server (110) across the network (105). The knowledge articles may be placed or assigned to a library in the data repository (160), or in an embodiment, a new library may be created in the data repository (160). For example, in the case of a new product line, a new library within the data repository (160) may be appropriate to separate the new product line from a prior product line. As shown herein, the knowledge base (160) is configured with domains and logically grouped activity data in the form of models and KGs. Knowledge articles may be present in the knowledge base (160), or solicited or acquired by the KG manager (152) from the various computing devices (180), (182), (184), (186), (188), and (190) in communication with the network (105).

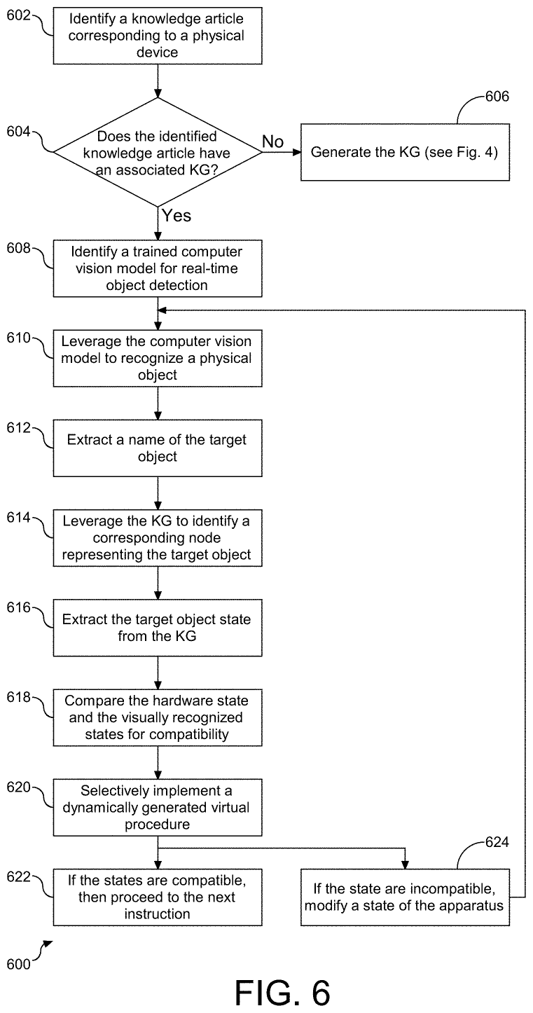

As shown herein, the director (156) is operatively coupled to the KG manager (152) and the computer vision manager (154). The director (156) is configured to leverage a trained computer vision model, such as one of the models stored in the second library (1620. In an embodiment, the computer vision model may be trained remotely and communicated to the director (156) across the network connection (105). The director (156) uses the trained computer vision model for real-time object state detection to localize an active state of a recognized physical component, e.g. physical object. The process of real-time object state detection is shown and described in FIG. 6. The director (156) leverages the computer vision model in conjunction with the corresponding KG to dynamically generate a virtual procedure instruction, with the dynamically generated instruction based on the localized and detected state of the physical object and corresponding hardware state characteristic data represented in the KG. More specifically, the director (156) leverages the computer vision model to extract a name of a target physical hardware object that is associated with an instruction, identify the extracted name in the corresponding KG, and leverage the KG to extract a target object state. Using the computer vision model, the director (156) identifies a visual state of the target object, and then conducts a comparison of the target object state as extracted from the KG with the visual state as identified by the computer vision model. The comparison entails the director (156) to compute a difference between the hardware state of the target object and the identified visual state of the object. In an exemplary embodiment, the similarity is computed through a trained neural network which predicts a probability of each state. The computer vision model leverages the computed difference to dynamically generate the virtual procedure instruction. In an embodiment, the computed difference is a numerical value that is assessed with respect to a configurable threshold, with the signal generated based on meeting the threshold.

As shown and described herein, the AI model creates output in the form of the dynamically generated virtual procedure instruction. The director (156) is configured to selectively generate the virtual procedure instruction. The signal manager (158) is shown herein operatively coupled to the AI platform (150). In an embodiment, the signal manager (158) may be embedded as a tool in the AI platform (150). In an embodiment, the virtual procedure instruction is directed at technical product repair and AR, and the signal manager functions as an interface between the virtual procedure instruction and the product, which in an embodiment includes synchronization of the generated procedure instruction and the state of a corresponding physical component. In an exemplary embodiment, the functionality of the director (156) and the signal manager (158) is directed to aligning the generated instruction and the state of the recognized physical object. In an embodiment, visual recognition accuracy of the computer vision model is supported by the KG. The signal manager (158) is configured to control an operatively coupled device, which in an embodiment is identified through the generated KG, with the generated signal based on the assessment of the detected object state and synchronization with an intended object state as support in the KG. In this networked arrangement, the server (110) and the network connection (105) enables transmission of the control signal to one of more of the computing devices (180), (182), (184), (186), (188), and (190), or in an embodiment an operatively coupled physical apparatus subject to the assessment and synchronization.

The generation of the instruction functions as an indicator or signal of implementation of a prior instruction via computer vision input and that a next step in the product repair is ready or necessitated. Similarly, in an embodiment, the generation of the instruction by the AI model is in response to the localized active state of the subject hardware element and the hardware state characteristic that is represented in the KG. The model creates output to process a subsequent instruction associated with the virtual procedure. Output from the model together with the synchronization assessment dictates selective issuance of the control signal, also referred to herein as an encoded action, with the control signal directed at a physical apparatus or component of the physical apparatus. In an exemplary embodiment the control signal facilitates or causes a change in the object state, physically transforming the object from a first state to a second state, Accordingly, the signal manager (158) interfaces with the computer vision model as support by the director (156) to selectively generate a control signal to ensure synchronization of the component recognition with the generated instruction, with the control signal to facilitate or cause transformation of the object state.

As described herein, the AI platform (150) and corresponding tools (152)-(158) is operatively coupled to the knowledge base (160), which includes one or more libraries with one or more KGs and models therein. The KG manager (152) creates and manages the KGs, with the KGs being a representation of a corresponding knowledge article. As shown and described, each KG is comprised of nodes and edges, with the nodes populated with the physical device components. Each edge connects two nodes, and the KG manager assigns characteristic data as provided in the corresponding knowledge article to each edge. In an embodiment, the knowledge article is a product manual with product repair instructions. As the product evolves, the product manual may be subject to change, with the KG manager (152) configured to update or amend the corresponding KG to reflect the updated or amendments. Examples of such updates include, but are not limited to, creating new nodes, removing existing nodes, creating new edges, and updating the data assigned to one or more of the edges. Accordingly, the KG actively and dynamically maintains the KG based on updates or amendments to a corresponding knowledge article, and further employs one or more dynamically maintained KGs in conjunction with the computer vision model to support remote object state recognition and selective transformation of the object state.

The processing of the knowledge articles into KG representations as managed by the KG manager (152), may be conducted online or in an embodiment offline or as one or more background processes. As described above, in the embodiment directed to online management, the KG manager (152) dynamically updated the KG based on changes or updates to the corresponding or represented knowledge article. The functionality of the computer vision manager (154), the director (156), and the signal manager (158) is conducted online to dynamically control a signal for selective implementation of the procedure instruction. The signal manager (158) is configured to selectively generate or issue a control signal to one or more of the apparatus to control an event injection. For example, the signal manager (158) may issue a control signal to modify, delay, or otherwise mitigate the effects of the procedure instruction on a corresponding physical apparatus or component thereof. Similarly, in an embodiment, the signal manager (158) may directly interface with the physical object as recognized by the corresponding model to modify or physical transform the physical object state. In another exemplary embodiment, the apparatus or component may be a product dispenser and the issued signal may modify a functional characteristic of the product dispenser, either physically or in a virtual environment, to align with the localized active state and the hardware state characteristic data. In an embodiment, the signal manager (158) computes a control action for a corresponding functional characteristic of the product, and selectively generates the control signal based on the computed control action. The control action may be applied as a feedback signal to directly control the event injection to maximize a likelihood of realizing an event, which in one embodiment may be an event that cannot be directly controlled. Accordingly, the signal manager (158) leverages the created, and in an embodiment dynamically maintained, KG and the computer vision model to selectively issue a control signal, or in an embodiment a feedback signal, to one or more physical devices that are the subject of the KG in order to control injection to support synchronization of the physical apparatus or component and the virtual procedure instruction.

The system and associated tools, as described herein, leverages AI to combine KG generation and maintenance with computer vision, and dynamically issues a signal, also referred to herein as a control signal, to control or modify an event injection to support the virtual procedure and associated instruction(s). The computer vision model leverages the KG and its architecture to sequences of events and corresponding transactions. It is understood in the art, that a child event is dependent on a parent event, and in an exemplary embodiment more than one parent event. As such, in an exemplary embodiment, the occurrence of a signal directed at a child event may be modified in some form by controlling a physical object state of the parent. In an embodiment, the signal manager (158) selectively controls an event injection based on the comparison of data reflected in the KG with extracted target object hardware state data. The control action may be applied as a feedback signal to directly control the event injection to maximize a likelihood of realizing an event, which in one embodiment may be an event that cannot be directly controlled. Accordingly, the signal manager (158) leverages the computer vision model and the generated KG to selectively implement a control signal, or in an embodiment a feedback signal, to one or more physical devices in order to control injection of an event into the physical apparatus.

As shown, the network (105) may include local network connections and remote connections in various embodiments, such that the AI platform (150) may operate in environments of any size, including local and global, e.g. the Internet. Additionally, the AI platform (150) serves as a front-end system that can make available a variety of knowledge extracted from or represented in network accessible sources and/or structured data sources. In this manner, some processes populate the AI platform (150), with the AI platform (150) also including input interfaces to receive requests and respond accordingly.

The network (105) may include local network connections and remote connections in various embodiments, such that the AI platform (150) may operate in environments of any size, including local and global, e.g. the Internet. Additionally, the AI platform (150) serves as a system that can make available a variety of knowledge extracted from or represented in network accessible sources and/or structured data sources. In this manner, some processes populate the AI platform (150), with the AI platform (150) also including one or more input interfaces or portals to receive requests and respond accordingly.

The AI platform (150) and the associated tools (152)-(158) leverage the knowledge base (160) and associated knowledge articles to support KG generation and maintenance, and to dynamically leverage the KG to orchestrate of one or more actions directed to device and communication optimization. Device processing data received across the network (105) may be processed by a server (110), for example IBM Watson® server, and the corresponding AI platform (150). As shown herein, the AI platform (150) together with the embedded tools (152)-(158) perform an analysis of computer vision data, dynamically conduct or update synchronization of the detected object state with an intended or documented product state, as well as generate one or more signals to physical modify the object state so that it is synchronized with the object state in the KG. Accordingly, the function of the tools and corresponding analysis and synchronization is to embed dynamic optimization of the detected physical object state.

In some illustrative embodiments, the server (110) may be the IBM Watson® system available from International Business Machines Corporation of Armonk, N.Y., which is augmented with the mechanisms of the illustrative embodiments described hereafter. The tools (152)-(158), hereinafter referred to collectively as AI tools, are shown as being embodied in or integrated within the AI platform (150) of the server (110). The AI tools may be implemented in a separate computing system (e.g., 190), or in one embodiment they can be implemented in one or more systems connected across network (105) to the server (110). Wherever embodied, the AI tools function to dynamically optimize device operation though object state modification and synchronization.

Types of devices and corresponding systems that can utilize the artificial intelligence platform (150) range from small handheld devices, such as handheld computer/mobile telephone (180) to large mainframe systems, such as mainframe computer (182). Examples of handheld computer (180) include personal digital assistants (PDAs), personal entertainment devices, such as MP4 players, portable televisions, and compact disc players. Other examples of information handling systems include pen, or tablet computer (184), laptop, or notebook computer (186), personal computer system (188), and server (190). As shown, the various devices and systems can be networked together using computer network (105). Types of computer network (105) that can be used to interconnect the various devices and systems include Local Area Networks (LANs), Wireless Local Area Networks (WLANs), the Internet, the Public Switched Telephone Network (PSTN), other wireless networks, and any other network topology that can be used to interconnect the devices and systems. Many of the devices and systems include nonvolatile data stores, such as hard drives and/or nonvolatile memory. Some of the devices and systems may use separate nonvolatile data stores (e.g., server (190) utilizes nonvolatile data store (190_{A}), and mainframe computer (182) utilizes nonvolatile data store (182_{A}). The nonvolatile data store (182_{A}) can be a component that is external to the various devices and systems or can be internal to one of the devices and systems.

The device(s) and system(s) employed to support the artificial intelligence platform (150) may take many forms, some of which are shown in FIG. 1. For example, an information handling system may take the form of a desktop, server, portable, laptop, notebook, or other form factor computer or data processing system. In addition, the device(s) and system(s) may take other form factors such as a personal digital assistant (PDA), a gaming device, ATM machine, a portable telephone device, a communication device or other devices that include a processor and memory.

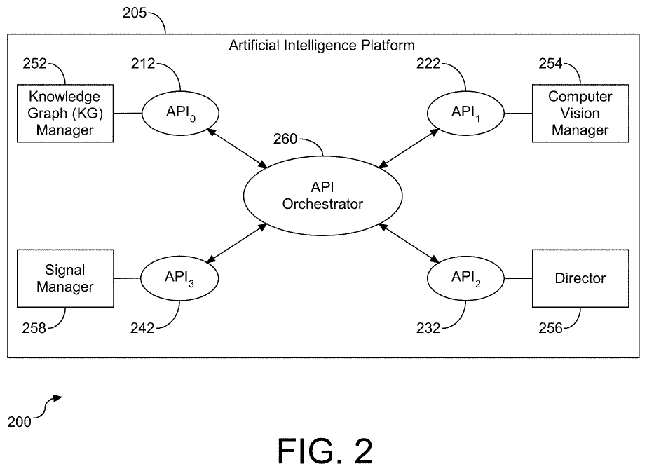

An Application Program Interface (API) is understood in the art as a software intermediary between two or more applications. With respect to the AI platform (150) shown and described in FIG. 1, one or more APIs may be utilized to support one or more of the tools (152)-(158) and their associated functionality. Referring to FIG. 2, a block diagram (200) is provided illustrating the tools (252)-(258) and their associated APIs. As shown, a plurality of tools is embedded within the AI platform (205), with the tools including the KG manager (152) shown herein as (252) associated with API₀ (212), the computer vision manager (154) shown herein as (254) associated with API₁ (222), the director (156) shown herein as (256) associated with API₂ (232), and the signal manager (158) shown herein as (258) associated with API₃ (242). Each of the APIs may be implemented in one or more languages and interface specifications. API₀ (212) provides functional support to interface with one or more knowledge articles to generate one or more corresponding KGs and to dynamically maintain the generated KG in view of changes to the corresponding knowledge article; API₁ (222) provides functional support for generating a KG from a corresponding knowledge article; API₂ (232) provides functional support for leveraging the trained computer vision model together with the generated KG to dynamically generate a virtual procedure instruction, and API₃ (242) provides functional support for dynamically issuing a control signal to an operatively coupled physical device that is associated with the generated virtual procedure instruction. As shown, each of the APIs (212), (222), (232), and (242) are operatively coupled to an API orchestrator (260), otherwise known as an orchestration layer, which is understood in the art to function as an abstraction layer to transparently thread together the separate APIs. In one embodiment, the functionality of the separate APIs may be joined or combined. As such, the configuration of the APIs shown herein should not be considered limiting. Accordingly, as shown herein, the functionality of the tools may be embodied or supported by their respective APIs.

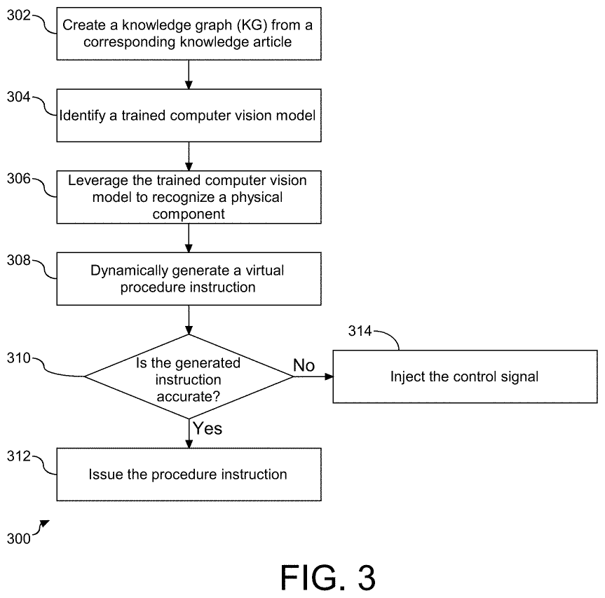

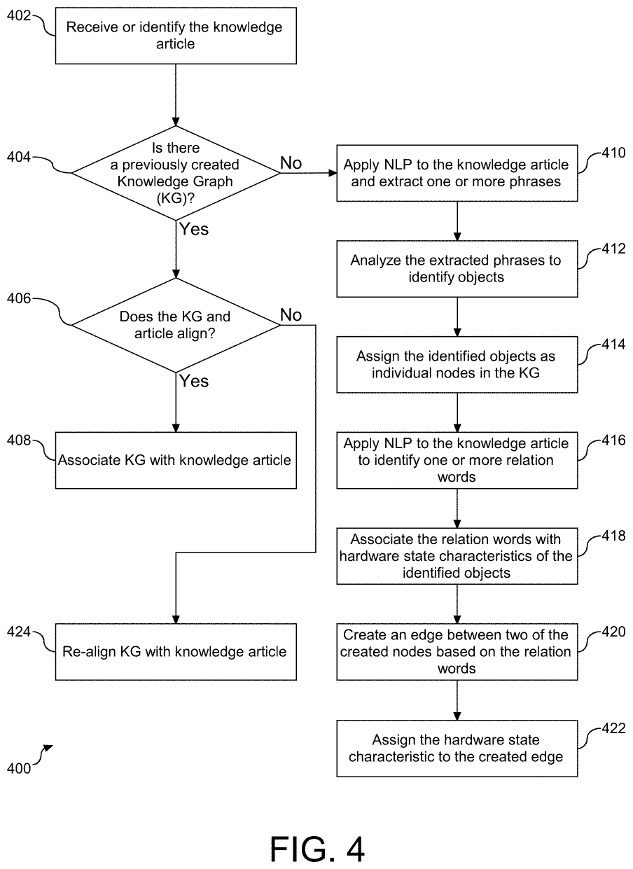

Referring to FIG. 3, a flow chart (300) is provided to illustrate creating and leveraging a knowledge graph to deliver comprehensive and context-specific AR guidance. The initial step is directed at creating the knowledge graph from a corresponding knowledge article (302). In an exemplary embodiment, the knowledge article may be a product maintenance technical document. Similarly, in an embodiment, the knowledge graph may have been previously created and associated with the knowledge article as reflected in the knowledge base. Details of the knowledge graph creation from a corresponding knowledge article are shown and described in FIG. 4. In addition to creation of the knowledge graph, a trained computer vision model for real-time object state detection is identified (304). In an exemplary embodiment, the identified trained computer vision model is configured to leverage annotated data, such as that represented in a corresponding KG. In an embodiment, the computer vision model is an artificial intelligence (AI) model, such as a visual recognition model. The trained computer vision model is leveraged to recognize a physical component, and to localize a state, also referred to herein as an active object state, of the recognized component (306). Thereafter, a virtual procedure instruction is dynamically generated based on both the localized active state of the recognized component, and hardware characteristic data represented in the KG (308). Details of the component recognition and the dynamic generation of the virtual procedure instruction is shown and described in FIG. 6. To ensure that the generated instruction is accurate, a synchronization assessment is conducted to evaluate the dynamically generated instruction with the localized active state of the recognized component (310). For example, in an embodiment, the generated instruction may be directed at a different component, or the same component but a different localized state, which would by evidence of non-synchronization. In an embodiment, evidence of the synchronization is supported in the generated KG. If at step (310) it is determined that synchronization is present, the procedure instruction is issued (312), and similarly, if it is determined that the synchronization is not present, than the control signal is injected (314), as supported and enabled by the signal manager (158). Accordingly, the KG creation together with the computer vision model integration supports and enables AR driven remote collaboration.

As shown and described herein, the object state detection and synchronization leverages a generated, and in an embodiment a dynamically maintained, KG. Referring to FIG. 4, a flow chart (400) is provided to illustrate a process for creating and dynamically maintaining the KG from a knowledge article. As shown and described in FIG. 1, the knowledge article may be stored in the knowledge base (160), or it may be received across the network connection (105). In an exemplary embodiment, the knowledge article may be associated with a hardware device, e.g. physical object or machine, and identified through an associated query. For example, the knowledge article may be a technical document in the form of a machine repair manual. As shown herein, the knowledge article is identified or received (402). In an embodiment, the identification of the knowledge article includes ascertaining that the knowledge article is pertinent to a specific hardware device or apparatus. As shown and described in FIG. 1, created KGs are stored in the knowledge base and associated with the corresponding knowledge article. Following step (402), it is determined if there is a previously created KG for the received or identified knowledge article (404). A positive response to the determination at step (404) is an indication that the KG already exists, or in an embodiment, a version of a previously created KG exits. Following a positive response to the determination at step (404), it is determined if the identified KG aligns with the knowledge article (406). For example, in an embodiment, the knowledge article may have been amended or updated since the prior version of the KG. In an exemplary embodiment, the KG includes metadata directed to the version of the knowledge article, and the assessment at step (406) determines if the version of the KG metadata matches the version in the metadata of the knowledge article. A positive response to the determination at step (406) is followed by associating the identified KG with the knowledge article, and the process of creating the KG is concluded (408).

As shown herein, a negative response to the determination at step (404) is an indication that there is no prior KG version for the knowledge article, and is followed by leveraging and applying Natural Language Processing (NLP) to the knowledge article to extract one or more phrases from the knowledge article (410), and to analyze the extracted phrases to identify the physical objects referenced therein (412). The identified objects are assigned or designated as individual nodes in the KG being formed (414). NLP is further leveraged and applied to the knowledge article to identify one or more relation words between two or more of the extracted phrases (416), and to associate with the identified relation word(s) with hardware state characteristics of the identified objects (418). An edge is created between two of the created nodes based on the identification of relation words (420), and the hardware state characteristic is assigned to the created edge connecting two nodes (422). Accordingly, the creation of the KG employs NLP to identify objects, assign the identified objects to nodes, identify relation words between the objects, create an edge between two nodes based on the identified relation words, and associate hardware characteristic data with each created node.

As articulated above, it is understood in the art that the knowledge article may be amended or replaced. For example, in the case of a product modification, the user's manual may be subject to an update or amendment to support and reflect the product modification. In an embodiment, the update of the user's manual may include a different version identifier to align with the product modification. A negative response to the determination at step (406) is an indication of the non-alignment, and is followed by re-alignment of the knowledge article with the identified KG (424). In an exemplary embodiment, the re-alignment at step (424) includes leveraging NLP to identify modified content. For example, in an embodiment a knowledge article corresponding to the identified KG and the knowledge article receive or identified at step (402) are subject to comparison to identified changed content. Using this modified content, the re-alignment process at step (424) incorporate steps (410)-(422) to selectively and dynamically amend the KG to reflect and incorporate the modified knowledge article content.

The created or updated KG is stored in the knowledge base (160) and associated with the corresponding knowledge article. Referring to FIG. 5, a diagram (500) is provided to illustrate an example KG for a computer system and associated components. As shown the physical device represented in the KG is a laptop computer (502) shown containing a battery (504) and a motherboard (506). Edge_{A} (504_{A}) shows the relationship between the laptop (502) and the battery (504), indicating the hardware state of contain. Similarly, edge_{B} (504_{B}) shows the relationship between the laptop (502) and the motherboard (506), indicating the hardware state of contain. The motherboard (506) is shown with four related components, including motherboard screws (510), fan screws (512), fan (514), hard disk (516), and CPU (518). A separate edge is provided between the motherboard and each of the related components. Namely, edge_{C} (512_{C}), edge_{D} (512_{D}), edge_{E} (512_{E}), edge_{F} (512_{F}), edge_{G} (512_{G}), and edge_{H} (512_{H}). In this example, the operable hardware state characteristics in each of edge_{C} (512_{C}), edge_{D} (512_{D}), edge_{E} (512_{E}), edge_{F} (512_{F}), edge_{G} (512_{G}) is ‘contains’, and the operable hardware state characteristic in edge_{H} (512_{H}) is ‘attached to’. The hard disk node (516) is shown related to hard disk screws (520) via edge_{I} (516_{I}), with the operable hardware state characteristic shown as ‘attached to’. Similarly, the fan node (514) is shown related to a heat sink (530) via edge_{J} (530_{J}) with the operable hardware state characteristic shown as ‘on top of’, and related to fan screws (512) via edge_{I} (540_{K}) with the operable hardware state characteristics shown as ‘attached to’. The heat sink node (530) is also shown related to the CPU (518) via edge_{L} (530_{L}) with the operable state characteristic of ‘on top of’. The edge arrow in the diagram illustrates dependency between the components and their corresponding characteristics. For example, the node (502), e.g. laptop, contains a motherboard (506) as represented by edge_{B} (504_{B}), and the node (512), e.g. fan screws, is attached to the fan (514) as represented by edge_{K} (540_{K}). Accordingly, the KG shown here is an example representation of physical objects, relations between such objects, and corresponding hardware state characteristic data.

The KG shown in FIG. 5 is an example KG created from a corresponding knowledge article, and the nodes and edges shown there are for exemplary purposes and should not be considered limiting. Referring to FIG. 6, a flow chart (600) is provided to illustrate leveraging the KG to support a virtual procedure and dynamic instruction generation. As shown and described herein, the KG in combination with a computer vision model supports and enables AR driven remote collaboration and self-enablement in the context of technical support. The computer vision model is leveraged to recognize a hardware component, and a machine learning model is leveraged to detect a hardware state of the recognized component. In an embodiment, the machine learning model is a deep learning model. NLP techniques are leveraged to understand instructions and their context. As shown, a knowledge article corresponding to a physical device is identified or otherwise ascertained (602). It is then determined if the identified knowledge article has an associated or corresponding KG (604). A negative response to the determination at step (604) is followed by a return to FIG. 4 (606) to generate the KG for the identified knowledge article, and a positive response is followed by identifying a trained a computer vision model for real-time object detection (6086). The trained computer vision model is leveraged to support and enable physical component and component state recognition.

AR addresses product repair through virtual procedures, which equip a technician with skills to support a range of hardware products. In an exemplary embodiment, virtual procedures are interactive two or three dimensional visual representations of text-based knowledge articles that describe how to perform a product repair or maintenance action. The computer vision model from step (6086) is leveraged to recognize a physical object or component, also referred to herein as a target object, and to localize an active or current state of the recognized object (610). A name of the target object is extracted (612). In an embodiment, NLP in the form of speech recognition is used to identify and understand the spoken name of the target object at step (612). The KG representation of the knowledge article is then leveraged to identify a corresponding node representing the target object (614), and to extract the target object state from the KG via the corresponding edges (616). A comparison of the localized object state ascertained at step (610) and the extracted target object state ascertained at step (616) is conducted (618). The comparison at step (618) leverages the relationships defined in the KG to compute the difference between a required hardware state and the visually recognized state, e.g. computes the difference between the states. For example, in the case of product repair and associated instructions, the comparison between states at step (618) may dictate a subsequent instruction. In an embodiment, the comparison at step (618) may be a determination if the hardware state and the visually recognized states are compatible, or in an embodiment incompatible. Following the comparison and computation at step (618), a dynamically generated virtual procedure instruction is selectively implemented (620). For example, if the result of the comparison indicates that the states are compatible, then the repair process may proceed to the next instruction (622), and if the states are determined as incompatible, then the repair process may send a signal to the physical apparatus or component to modify a state of the apparatus or component (624) followed by a return to step (610). Accordingly, the virtual instructions are dynamically and selectively supported via the KG representation of the hardware components.

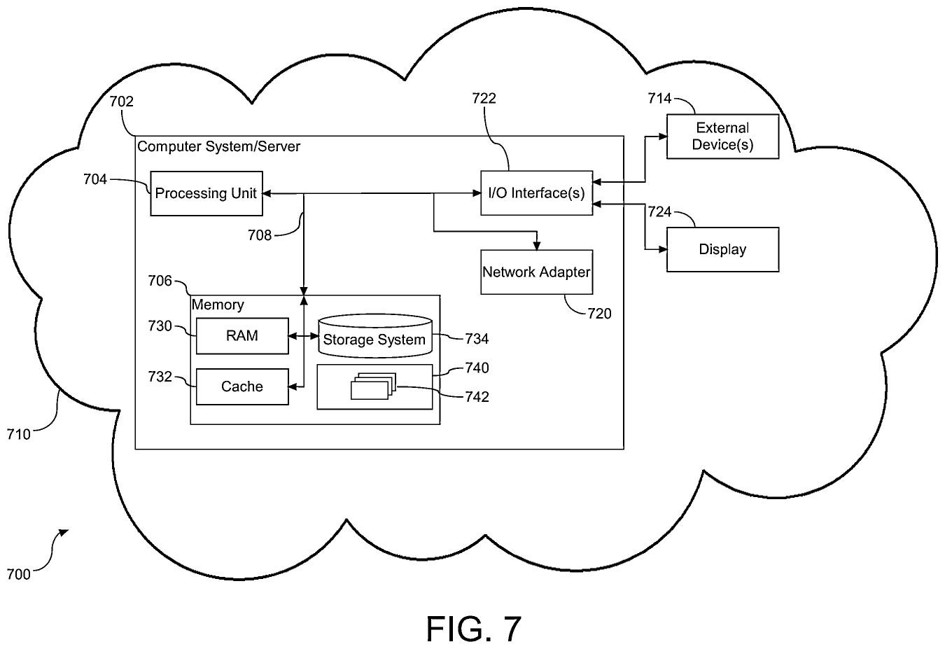

Embodiments shown and described herein may be in the form of a computer system for use with an intelligent computer platform for providing orchestration of activities across one or more domains to minimize risk. Aspects of the tools (152)-(158) and their associated functionality may be embodied in a computer system/server in a single location, or in one embodiment, may be configured in a cloud based system sharing computing resources. With reference to FIG. 7, a block diagram (700) is provided illustrating an example of a computer system/server (702), hereinafter referred to as a host (702) in a cloud computing environment (710), to implement the system, tools, and processes described above with respect to FIGS. 1-6. Host (702) is operational with numerous other general purpose or special purpose computing system environments or configurations. Examples of well-known computing systems, environments, and/or configurations that may be suitable for use with host (702) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and file systems (e.g., distributed storage environments and distributed cloud computing environments) that include any of the above systems, devices, and their equivalents.

Host (702) may be described in the general context of computer system-executable instructions, such as program modules, being executed by a computer system. Generally, program modules may include routines, programs, objects, components, logic, data structures, and so on that perform particular tasks or implement particular abstract data types. Host (702) may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, host (702) is shown in the form of a general-purpose computing device. The components of host (702) may include, but are not limited to, one or more processors or processing units (704), e.g. hardware processors, a system memory (706), and a bus (708) that couples various system components including system memory (706) to processor (704). Bus (708) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Host (702) typically includes a variety of computer system readable media. Such media may be any available media that is accessible by host (702) and it includes both volatile and non-volatile media, removable and non-removable media.

Memory (706) can include computer system readable media in the form of volatile memory, such as random access memory (RAM) (730) and/or cache memory (732). By way of example only, storage system (734) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (708) by one or more data media interfaces.

Program/utility (740), having a set (at least one) of program modules (742), may be stored in memory (706) by way of example, and not limitation, as well as an operating system, one or more application programs, other program modules, and program data. Each of the operating systems, one or more application programs, other program modules, and program data or some combination thereof, may include an implementation of a networking environment. Program modules (742) generally carry out the functions and/or methodologies of embodiments to dynamically orchestrate of activities across one or more domains to minimize risk. For example, the set of program modules (742) may include the tools (152)-(156) as described in FIG. 1.

Host (702) may also communicate with one or more external devices (714), such as a keyboard, a pointing device, etc.; a display (724); one or more devices that enable a user to interact with host (702); and/or any devices (e.g., network card, modem, etc.) that enable host (702) to communicate with one or more other computing devices. Such communication can occur via Input/Output (I/O) interface(s) (722). Still yet, host (702) can communicate with one or more networks such as a local area network (LAN), a general wide area network (WAN), and/or a public network (e.g., the Internet) via network adapter (720). As depicted, network adapter (720) communicates with the other components of host (702) via bus (708). In one embodiment, a plurality of nodes of a distributed file system (not shown) is in communication with the host (702) via the I/O interface (722) or via the network adapter (720). It should be understood that although not shown, other hardware and/or software components could be used in conjunction with host (702). Examples, include, but are not limited to: microcode, device drivers, redundant processing units, external disk drive arrays, RAID systems, tape drives, and data archival storage systems, etc.

In this document, the terms “computer program medium,” “computer usable medium,” and “computer readable medium” are used to generally refer to media such as main memory (706), including RAM (730), cache (732), and storage system (734), such as a removable storage drive and a hard disk installed in a hard disk drive.

Computer programs (also called computer control logic) are stored in memory (706). Computer programs may also be received via a communication interface, such as network adapter (720). Such computer programs, when run, enable the computer system to perform the features of the present embodiments as discussed herein. In particular, the computer programs, when run, enable the processing unit (704) to perform the features of the computer system. Accordingly, such computer programs represent controllers of the computer system.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the embodiments.

In one embodiment, host (702) is a node of a cloud computing environment. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Example of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher layer of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some layer of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

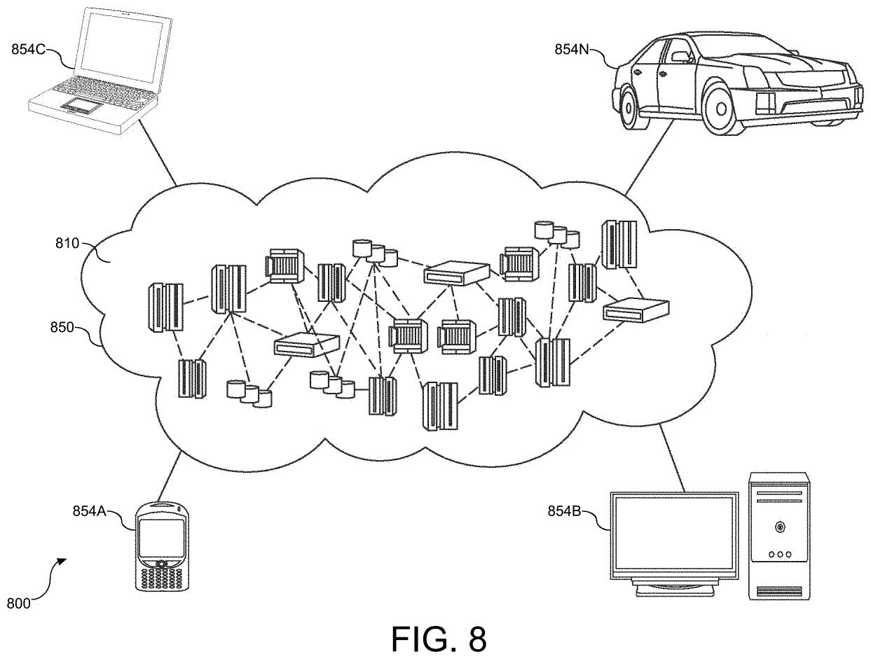

Referring now to FIG. 8, an illustrative cloud computing network (800). As shown, cloud computing network (700) includes a cloud computing environment (850) having one or more cloud computing nodes (810) with which local computing devices used by cloud consumers may communicate. Examples of these local computing devices include, but are not limited to, personal digital assistant (PDA) or cellular telephone (854A), desktop computer (854B), laptop computer (854C), and/or automobile computer system (854N). Individual nodes within nodes (810) may further communicate with one another. They may be grouped (not shown) physically or virtually, in one or more networks, such as Private, Community, Public, or Hybrid clouds as described hereinabove, or a combination thereof. This allows cloud computing environment (800) to offer infrastructure, platforms and/or software as services for which a cloud consumer does not need to maintain resources on a local computing device. It is understood that the types of computing devices (854A-N) shown in FIG. 8 are intended to be illustrative only and that the cloud computing environment (850) can communicate with any type of computerized device over any type of network and/or network addressable connection (e.g., using a web browser).

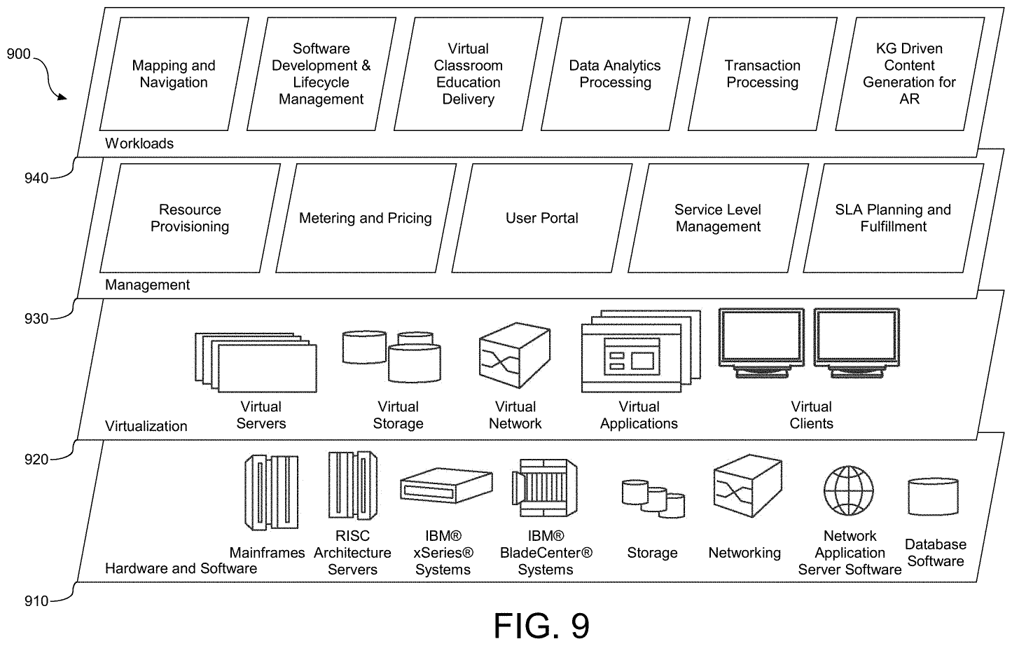

Referring now to FIG. 9, a set of functional abstraction layers (900) provided by the cloud computing network of FIG. 8 is shown. It should be understood in advance that the components, layers, and functions shown in FIG. 9 are intended to be illustrative only, and the embodiments are not limited thereto. As depicted, the following layers and corresponding functions are provided: hardware and software layer (910), virtualization layer (920), management layer (930), and workload layer (940).

The hardware and software layer (910) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (920) provides an abstraction layer from which the following examples of virtual entities may be provided: virtual servers; virtual storage; virtual networks, including virtual private networks; virtual applications and operating systems; and virtual clients.

In one example, management layer (930) may provide the following functions: resource provisioning, metering and pricing, user portal, service layer management, and SLA planning and fulfillment. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service layer management provides cloud computing resource allocation and management such that required service layers are met. Service Layer Agreement (SLA) planning and fulfillment provides pre-arrangement for, and procurement of, cloud computing resources for which a future requirement is anticipated in accordance with an SLA.

Workloads layer (940) provides examples of functionality for which the cloud computing environment may be utilized. Examples of workloads and functions which may be provided from this layer include, but are not limited to: mapping and navigation; software development and lifecycle management; virtual classroom education delivery; data analytics processing; transaction processing; and KG driven content generation for AR.

It will be appreciated that there is disclosed herein a system, method, apparatus, and computer program product for evaluating natural language input, detecting an interrogatory in a corresponding communication, and resolving the detected interrogatory with an answer and/or supporting content.

While particular embodiments of the present embodiments have been shown and described, it will be obvious to those skilled in the art that, based upon the teachings herein, changes and modifications may be made without departing from the embodiments and its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to embodiments containing only one such element, even when the same claim includes the introductory phrases “one or more” or “at least one” and indefinite articles such as “a” or “an”; the same holds true for the use in the claims of definite articles.

The present embodiments may be a system, a method, and/or a computer program product. In addition, selected aspects of the present embodiments may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the present embodiments may take the form of computer program product embodied in a computer readable storage medium (or media) having computer readable program instructions thereon for causing a processor to carry out aspects of the present embodiments. Thus embodied, the disclosed system, a method, and/or a computer program product are operative to improve the functionality and operation of an artificial intelligence platform to as supported by KG driven content generation for AR.

Aspects of the present embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that, although specific embodiments have been described herein for purposes of illustration, various modifications may be made without departing from the spirit and scope of the embodiments. In particular, creating the KG, leveraging the computer vision model, dynamically generating a signal or instruction, and the synchronization may be carried out by different computing platforms or across multiple devices. Furthermore, the data storage and/or corpus may be localized, remote, or spread across multiple systems. Accordingly, the scope of protection of the embodiments is limited only by the following claims and their equivalents.

What is claimed is:

1. A computer system comprising:
a processing unit operatively coupled to memory;
an artificial intelligence (AI) platform, in communication with the processing unit, having one or more tools to support knowledge graph (KG) driven content generation, the tools comprising:
a KG manager configured to create a KG from one or more knowledge articles, the KG including nodes and edges, with individual nodes representing a physical object and an individual edge representing a hardware state characteristic of the physical object; and
a director configured to leverage a trained computer vision model to recognize one or more physical components, including localize an active state of the recognized one or more physical components, and dynamically generate content responsive to the localized active state and the hardware state characteristic represented in the KG; and
a signal manager configured to dynamically issue a control signal to an operatively coupled device associated with the generated content, the control signal configured to selectively control an event injection responsive to synchronization of the recognized one or more physical components and the generated content.

2. The computer system of claim 1, wherein the dynamic issuance of the control signal further comprises the computer vision model to leverage spatial recognition of the one or more physical components, and the signal manager to selectively compute a control action to support synchronization.

3. The computer system of claim 1, wherein creation of the KG further comprises the KG manager to employ natural language processing (NLP) to extract one or more phrases from the one or more knowledge articles, and analyze the extracted one or more phrases referring to one or more physical objects.

4. The computer system of claim 3, wherein the NLP is configured to identify one or more relation words between two or more of the extracted phrases, and further comprising the KG manager configured to associate the identified one or more relation words with the hardware state characteristic.

5. The computer system of claim 4, wherein the dynamic generation of the content is responsive to the localized active state and the hardware state characteristic represented in the KG, and further comprises the director to leverage the computer vision model to:
extract a name of a target physical hardware object associated with an instruction, identify the extracted name in the KG, and leverage the KG to extract a target object hardware state;
identify a visual state of the target object using the computer vision model; and
compare the extracted target object hardware state acquired from the KG with the identified visual state.

6. The computer system of claim 5, wherein the comparison of the extracted target object hardware state with the identified visual state further comprises the director configured to compute a difference between the hardware state of the target object and the identified visual state.

7. The computer system of claim 6, wherein the dynamically generated content is responsive to the computed difference.

8. A computer program product to support knowledge graph (KG) driven content generation, the computer program product comprising a computer readable storage medium having program code embodied therewith, the program code executable by a processor to:
create a KG from one or more knowledge articles, the KG including nodes and edges, with individual nodes representing a physical object and an individual edge representing a hardware state characteristic of the physical object;
leverage a trained computer vision model to recognize one or more physical components, including localize an active state of the recognized one or more physical components;
dynamically generate content responsive to the localized active state and the hardware state characteristic represented in the KG; and
dynamically issue a control signal to an operatively coupled device associated with the generated content, the control signal configured to selectively control an event injection responsive to synchronization of the recognized one or more physical components and the generated content.

9. The computer program product of claim 8, wherein the dynamic issuance of the control signal further comprises the computer vision model to leverage spatial recognition of the one or more physical components, and program code to selectively compute a control action to support synchronization.

10. The computer program product of claim 8, wherein the KG creation further comprises program code configured to employ natural language processing (NLP) to extract one or more phrases from the one or more knowledge articles, and analyze the extracted one or more phrases referring to one or more physical objects.

11. The computer program product of claim 10, further comprising the NLP configured to identify one or more relation words between two or more of the extracted phrases, and associate the identified one or more relation words with the hardware state characteristic.

12. The computer program product of claim 11, wherein the program code to dynamically generate content responsive to the localized active state and the hardware state characteristic represented in the KG further comprises program code configured to:
extract a name of a target physical hardware object associated with an instruction, identify the extracted name in the KG, and leverage the KG to extract a target object hardware state;
identify a visual state of the target object using the computer vision model; and
compare the extracted target object hardware state acquired from the KG with the identified visual state.

13. The computer program product of claim 12, wherein the comparison of the extracted target object hardware state with the identified visual state further comprises program code configured to compute a difference between the hardware state of the target object and the identified visual state.

14. The computer program product of claim 13, wherein the dynamically generated content is responsive to the computed difference.

15. A computer implemented method, comprising:
creating a knowledge graph (KG) from one or more knowledge articles, the KG including nodes and edges, with individual nodes representing a physical object and an individual edge representing a hardware state characteristic of the physical object;
leveraging a trained computer vision model for recognizing one or more physical components in real-time, including localizing an active state of the recognized one or more physical components;
dynamically generating content responsive to the localized active state and the hardware state characteristic represented in the created KG; and
dynamically issuing a control signal to an operatively coupled device associated with the generated content, the control signal configured to selectively control an event injection responsive to synchronization of the recognized one or more physical components and the generated content.

16. The computer implemented method of claim 15, wherein the dynamic issuance of the control signal further comprises computer vision model leveraging spatial recognition of the one or more physical components, and selectively computing a control action to support synchronization.

17. The computer implemented method of claim 15, wherein creating the KG further comprises employing natural language processing (NLP) to extract one or more phrases from the one or more knowledge articles, and analyzing the extracted one or more phrases referring to one or more physical objects.

18. The computer implemented method of claim 17, further comprising the NLP identifying one or more relation words between two or more of the extracted phrases, and associating the identified one or more relation words with the hardware state characteristic.

19. The computer implemented method of claim 18, wherein dynamically generating the content responsive to the localized active state and the hardware state characteristic represented in the KG further comprises:
extracting a name of a target physical hardware object associated with an instruction, identifying the extracted name in the KG, and leveraging the KG to extract a target object hardware state;
identifying a visual state of the target object using the computer vision model; and
comparing the extracted target object hardware state acquired from the KG with the identified visual state.

20. The computer implemented method of claim 19, wherein comparing the extracted target object hardware state with the identified visual state further comprises computing a difference between the hardware state of the target object and the identified visual state.
